(19) United States
(12) Patent Application Publication
(10) Pub. No.: US 2018/0201362 A1
(43) Pub. Date: Jul. 19, 2018

(54) AIRCRAFT WITH A VARIABLE FUSELAGE SURFACE FOR BOUNDARY LAYER OPTIMIZATION

(71) Applicant: Airbus Operations, S.L., Madrid (ES)

(72) Inventors: Alberto Arana Hidalgo, Getafe (ES); Raúl Carlos Llamas Sandín, Getafe (ES); Jesús Javier Vázquez Castro, Getafe (ES)

(21) Appl. No.: 15/849,250

(22) Filed: Dec. 20, 2017

(30) Foreign Application Priority Data
Dec. 21, 2016 (EP) 16382634.0

(51) Int. Cl. B64C 21/10; B64C 21/06; B64D 29/04

(52) U.S. Cl. CPC B64C 21/10; B64D 29/04; B64C 21/06

(57) ABSTRACT

An aircraft including a propulsion system formed by engines arranged to ingest boundary layer air. These engines are placed inside of nacelles partially embedded in the aircraft fuselage and, thus, their intake conduits are delimited by specific fuselage areas and the nacelles. For the specific fuselage areas skins are disclosed with a flexible portion and actuation systems over them for changing their surfaces to adapt them to the needs of the propulsion system.

### CROSS-REFERENCE TO RELATED APPLICATION

This application claims the benefit of and priority to European patent application No. 16382634.0 filed on Dec. 21, 2016, the entire disclosure of which is incorporated by reference herein.

### TECHNICAL FIELD

The present disclosure relates to aircraft with engines arranged to ingest boundary layer air and more particularly to aircraft with engines attached directly to the aircraft fuselage.

### BACKGROUND

Although the engines of conventional aircraft for passenger or cargo transportation are usually arranged inside nacelles that are joined to the wings or to the fuselage by pylons, there are also known aircraft with the engine nacelles partially embedded in the aircraft fuselage such as the aircraft of FIG. 1 with two engines located in the rear fuselage.

These aircraft configurations are intended both for eliminating the pylons (what reduces weight and drag) and for housing Boundary Layer Ingestion (BLI) engines.

Partially embedded nacelles allow using BLI engines that can improve the engine efficiency by the ingestion of the lower speed boundary layer flow.

One of the problems raised by these aircraft configurations is related with the flow control in the intake conduit of the engines.

In this respect US 2011/0163207 discloses an airplane provided with dual-flow turbojet engines wherein the air intake of each engine is connected to the fuselage by two boundary layer guiding walls, the walls extending towards the upstream side of the air intake and being spaced apart towards the upstream side.

Moreover U.S. Pat. No. 7,784,732 B2 discloses a system for reducing distortion at the aerodynamic interface plane of a boundary-layer-ingesting inlet using a combination of active and passive flow control devices. Active flow control jets and vortex generating vanes are used in combination to reduce distortion across a range of inlet operating conditions. Together, the vortex generating vanes can reduce most of the inlet distortion and the active flow control jets can be used at a significantly reduced control jet mass flow rate to make sure the inlet distortion stays low as the inlet mass flow rate varies.

The present disclosure also addresses improving the flow control in the intake conduit but focusing the problem from a different perspective.

### SUMMARY

The disclosure herein refers to an aircraft comprising a propulsion system formed by engines arranged to ingest boundary layer air. These engines are placed inside of nacelles partially embedded in the aircraft fuselage and, thus, their intake conduits are delimited or defined by specific fuselage areas and the nacelles.

For the specific fuselage areas, the disclosure herein provides skins with a flexible portion and actuation systems over them for changing their surfaces to adapt them to the needs of the propulsion system. In other words, the disclosure herein provides a variable range of performance to the air current used for the boundary layer ingestion engine.

In an embodiment the skins comprise inner flexible portions, such as membranes made of an elastomeric material or a composite material, attached to surrounding rigid shells which are joined to inner structural elements of the specific fuselage areas.

In an embodiment the inner flexible portions have a semi-rigid grid embedded into them, being some of their nodes the points to be actuated by the actuation systems. In an embodiment the actuation systems comprise linear actuators supported by the inner structural elements and connected with some nodes of the inner flexible portions of the skins.

Other desirable features and advantages of the disclosure herein will become apparent from the subsequent detailed description in relation to the associated figures of example drawings.

### BRIEF DESCRIPTION OF THE DRAWINGS

FIG. 1A is a schematic perspective view of an aircraft with two engines placed inside of a nacelle partially embedded in the rear fuselage.

FIG. 1B is a plan schematic view of the circled area of FIG. 1A.

FIG. 2 is a schematic sectional view by the plane A-A′ of FIG. 1A corresponding to a known aircraft.

FIG. 3 is a schematic sectional views by the plane A-A′ of FIG. 1A corresponding to an aircraft according to the disclosure herein.

FIGS. 4A and 4B are separated schematic perspective views of the rigid and flexible portions of the skin of the fuselage area belonging to the intake conduit of an engine in an embodiment of the disclosure herein.

FIGS. 5A, 5B and 5C are schematic perspective views of the skin of a fuselage area belonging to the intake conduit of an engine illustrating three different states of the surface of its flexible portion.

### DETAILED DESCRIPTION

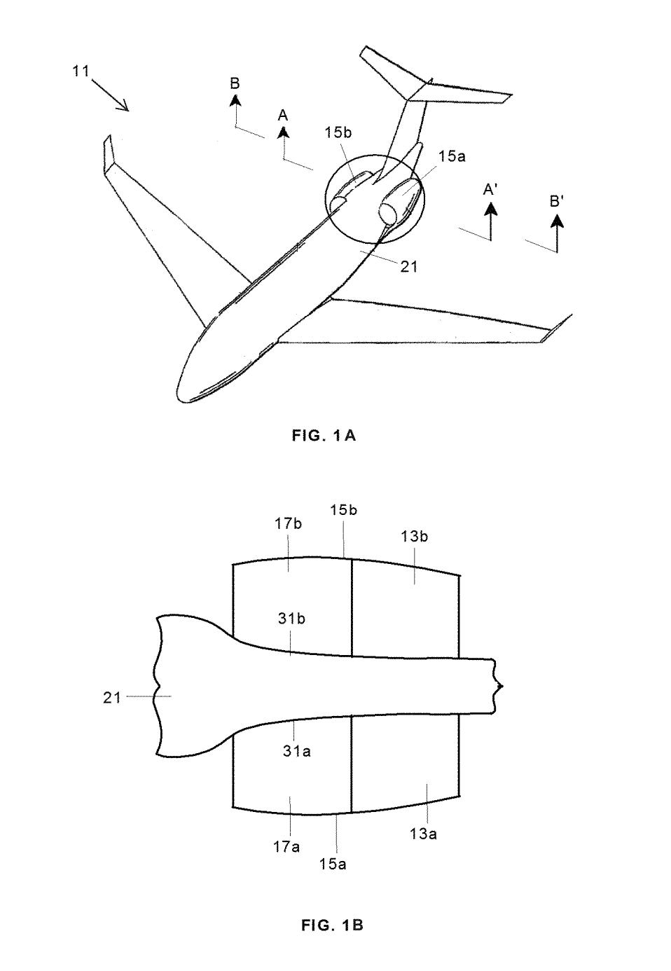

FIG. 1A and FIG. 1B show an aircraft 11 with a propulsion system formed by engines 13a, 13b placed inside nacelles 15a, 15b partially embedded in an aircraft fuselage 21 and arranged to ingest boundary layer air.

In known aircraft (see FIG. 1B) the engines 13a, 13b receive the incoming air through intake conduits 17a, 17b delimited or defined by the nacelles 15a, 15b and the areas 31a, 31b of the aircraft fuselage 21.

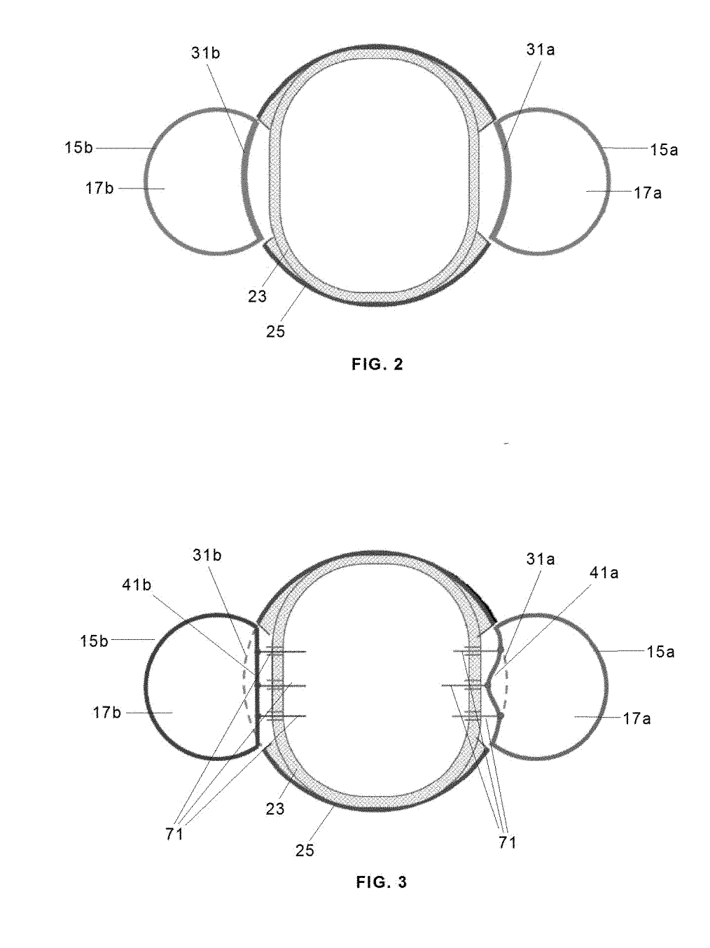

In aircraft with conventional fuselage structures such as frames 23 and a rigid skin 25 (see FIG. 2), the shape of the fuselage areas 31a, 31b belonging to the intake conduits 17a, 17b conditions the performance of the engines 13a, 13b, placed inside the nacelles 15a, 15b.

In the embodiment of the disclosure herein illustrated in FIGS. 3-5C, in the section corresponding to the fuselage areas 31a, 31b, the aircraft fuselage 21, comprises inner structural elements 23, 24 (typically frames and beams/stiffeners), skins 41a, 41b with inner flexible portions 43a, 43b attached to surrounding rigid portions 45a, 45b joined to the inner structural elements 23, 24 and actuation systems over the flexible portions 43a, 43b of the skins 41a, 41b to change the surface of the fuselage areas 31a, 31a to adapt them to the needs of the propulsion system.

In this respect FIG. 3 shows the left skin 41b in a situation where its actuation system is inactive and the right skin 41a in a situation where its actuation system is active.

These needs may refer to an adaptation of the fuselage areas 31a, 31b to new engines with different features than the previous engines housed in nacelles 15a, 15b, to desired modifications of the geometry of the intake conduits 17a, 17b or to different engine regime points during a mission.

If the skin of the fuselage areas 31a, 31b is a rigid skin it can only be optimum for a specific engine, intake and engine regime.

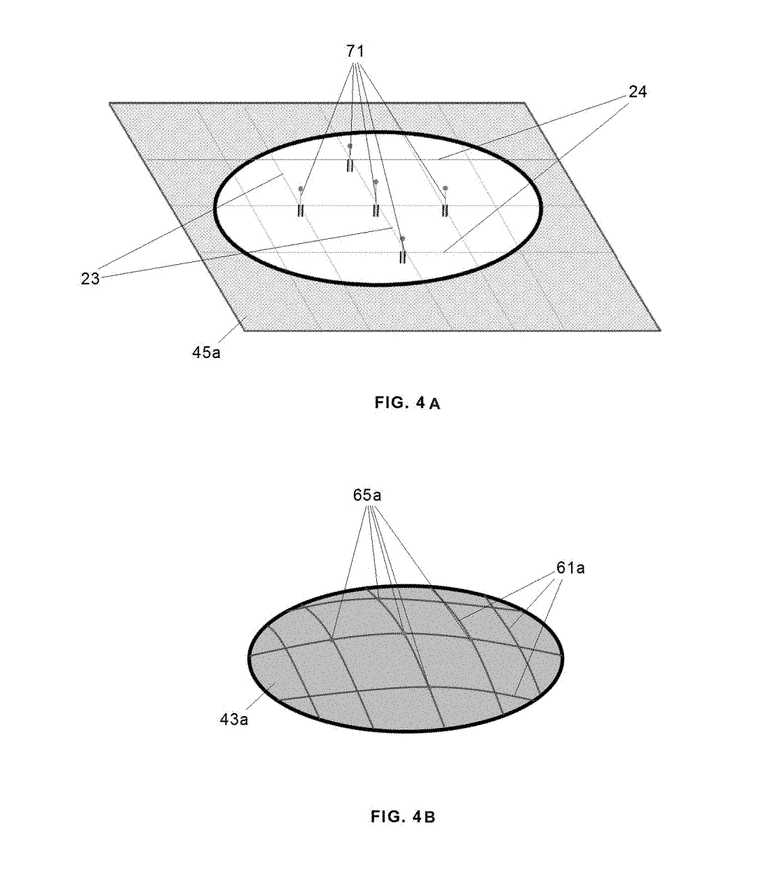

In an embodiment the inner flexible portions 43a, 43b of the skins 41a, 41b have a semi-rigid grid 61a, 61b embedded into them with some of their nodes 65a, 65b being configured as the points to be actuated by actuation systems comprising linear actuators 71 supported in the inner structural elements 23, 24 (see particularly FIGS. 4A-4B).

In an embodiment the inner flexible portions 43a, 43b of skins 41a, 41b are membranes made of an elastomeric material.

In another embodiment the inner flexible portions 43a, 43b of skins 41a, 41b are membranes made of a composite material such as CFRP (if thin enough) to maintain the equilibrium between being deformable upon the actuation system but do not vibrate under normal air ingestion conditions to do not introduce perturbations on the inflow of air.

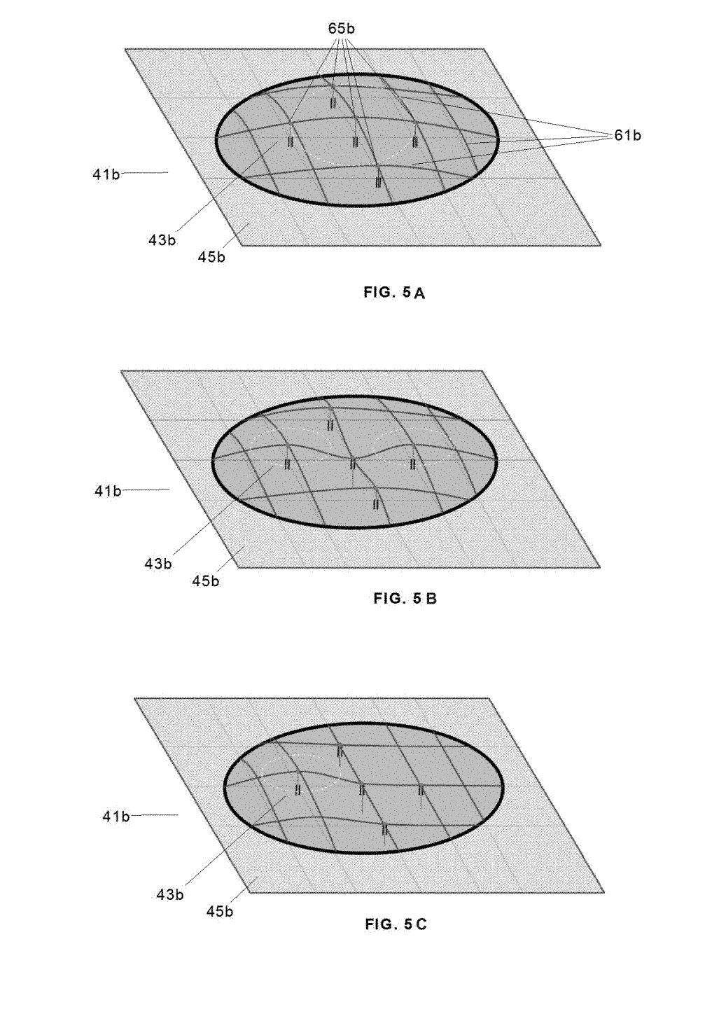

The actuation systems are configured with the linear actuators 71 connected with some nodes 65a, 65b of the semi-rigid grid 61a, 61b of the flexible portions 43a, 43b of skins 41a, 41b and arranged to move forwards or backwards to allow different configurations of the flexible portions 43a, 43b as shown, particularly, in FIGS. 5A-5C to adapt them to the needs of the propulsion system.

In the embodiment illustrated in FIG. 5A all linear actuators 71 are moved forwards so that the flexible portion 43b has a dome shape.

In the embodiment illustrated in FIG. 5B four linear actuators 71 are moved forwards and the central lineal actuator is moved backwards to configure the flexible portion 43b with a central depression.

In the embodiment illustrated in FIG. 5C only one linear actuator 71 is moved forwards to configure the flexible portion 43b with a bulb in the left side.

Although the present disclosure has been described in connection with various embodiments, it will be appreciated from the specification that various combinations of elements, variations or improvements therein may be made, and are within the scope of the disclosure herein as defined by the appended claims.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising a propulsion system formed by engines arranged to ingest boundary layer air, the engines being inside of nacelles partially embedded in an aircraft fuselage of the aircraft, the intake conduits of the engines being defined by fuselage areas and the nacelles, wherein, in a fuselage section corresponding to the fuselage areas, the aircraft comprises:
inner structural elements;
skins with flexible portions in the fuselage areas; and
actuation systems for changing surfaces of the flexible portions of skins to adapt them to needs of the propulsion system.

2. The aircraft according to claim 1, wherein the skins comprise inner flexible portions attached to surrounding rigid shells which are joined to the inner structural elements.

3. The aircraft according to claim 2, wherein the inner flexible portions of the skins have a semi-rigid grid embedded into the inner flexible portions, and comprising nodes configured as points to be actuated by the actuation systems.

4. The aircraft according to claim 3, wherein the flexible portions of the skins are membranes made of an elastomeric material.

5. The aircraft according to claim 3, wherein the flexible portions of the skins are membranes made of a composite material.

6. The aircraft according to claim 3, wherein the actuation systems comprise linear actuators supported by the inner structural elements and connected with some of the nodes of the inner flexible portions of the skins.

7. The aircraft according to claim 1, wherein the engines housed in the nacelles are located in a rear of the fuselage.
